(19) United States
(12) Patent Application Publication
(10) Pub. No.: US 2022/0034838 A1
(43) Pub. Date: Feb. 3, 2022

(54) Flip Chip Thin Film Hybrid Screen Printed Electrode Test Strip

(71) Applicant: Xin Zhao, North Potomac, MD (US)

(72) Inventors: Wei Zheng, Williamsburg, VA (US); Xin Zhao, North Potomac, MD (US)

(21) Appl. No.: 16/943,914

(22) Filed: Jul. 30, 2020

(51) Int. Cl. G01N 27/414

(52) U.S. Cl. CPC G01N 27/4148; G01N 27/4145; G01N 27/4146

(57) ABSTRACT

This invention is about a product of a flip chip thin film hybrid screen printed electrode. It combines a primary screen printed electrode (SPE) device and a thin film material coated chip, in order to make a hybridized product. The product is used as a test strip for electrochemical analysis, such as environmental, bio-electrochemical and biomedical sensors. The hybridized electrodes design takes the benefits of low cost of screen printing technology, and high sensitivity of thin film coating nanotechnology. This invention is also about applying a flip chip method to manufacture the hybrid electrode. A chip of thin film material coated solid state substrate is surface mounted to a preliminary perforated SPE by a flip chip method/process. This method/process is fast, easy, cheap, uniform, and suitable for large scale manufacturing.

This is the Nonprovisional application for a former provisional application with the title “ Flip Chip Thin Film Hybrid Screen Printed Electrode Test Strip”, submitted on Jul. 8, 2019. EFS ID: 36511070, Application No. 62/871,233

### BACKGROUND OF THE INVENTION

### FIELD OF THE INVENTION

This invention is in the technical field of analytic electrochemistry. More particularly, it is about electrode products for electrochemical analysis.

Electrochemistry deals with the interaction between electrical signals and chemical states change, and is a branch of physical chemistry. There are various very important electrochemical processes, like the coating of thin layers to an object's surface, the detection of alcohol, blood sugar (glucose), drug abuse of a person, the generation of chemical energy and storage of energy, e.g. batteries, fuel cells, and super-capacitors, the detection of heavy metal or other pollution in soil and water, the detection of harmful substances in the food industry, and disease diagnosis in medicals. All of these reactions involve electric charges moving between electrodes and an electrolyte. Electrodes are very critical parts in electrochemical systems because they conduct the electric charges and are the places where reactions happen. To develop disposable low cost electrodes and to enhance the efficiency and sensitivity in various applications are two major motivations.

Screen printed electrodes (SPE) test strips are conventionally made via a mature screen printing technology, which uses a scrub pad to print a variety of ink materials to a low cost substrate material. The mostly well-known SPE are the test strips for monitoring blood glucose of human diabetic disease. The choice of a substrate for SPE, is different from that of a solid state substrate for thin film materials coatings. This SPE manufacturing process is fast, cheap and suitable for large scale production and has been adopted by analytic electrochemistry industry.

On the other hand, researchers are developing new work electrode materials to pursue higher efficiency and sensitivity. These new work electrode materials often contain a thin film, such as gold nano arrays, graphene materials, nano catalytic particles, etc.

In this patent, we invent an electrochemical analysis product, combining the benefits of screen printed materials as well as a thin film coated material as electrodes.

As a thin film material, a vertically free standing graphene containing Carbon Nanosheet (abbr.“VG”, a.k.a “Carbon Nanosheets”) is a novel carbon nanomaterial with a range of graphene and graphitic crystal structure invented by Dr. J. J. Wang et al. at the College of William and Mary. Dr. W. Zheng et al. further invented a novel method to grow this material safer, faster, and affordable for mass production. As used herein, a “Carbon Nanosheet” refers to a carbon nanomaterial with a thickness of three nanometers or less. A Carbon Nanosheet is a two-dimensional graphitic sheet made up of a single to ten atomic layers of graphene. Carbon Nanosheet is a Few-Layer Graphene material based on international graphene vocabulary standard. Edges of a Carbon Nanosheet usually terminate by a single layer of graphene. The specific surface area of a Carbon Nanosheet is between 1000 m2/g to 2600 m2/g. The height of a Carbon Nanosheet varies from 100 nm to 8 μm, depending on fabrication conditions. The width of a Carbon Nanosheet also varies from hundreds of nanometers to a few microns. A plurality of Carbon Nanosheets, each of which comprises at least one layer of graphene, are disposed orthogonally to a coated surface of a substrate. Essentially, the plurality of vertically free standing Carbon Nanosheets are functioning as space-organizers at nanoscale. By partitioning the space above the surface of the substrate, these vertically free standing Carbon Nanosheets can greatly enlarge the surface area of the substrate.

Hereby the term “free-standing” or the term “vertically free standing” refers to in-situ self-organized growth of carbon nanostructures to a surface semi-orthogonally, or at various angles from 0 to 180 degree with respect to the surface. Furthermore, nanostructures of Carbon Nanosheet stretch out not only in a straight way, but also can have a crumpling, tilting, folding, sloping, or “origami”-like structure. A variety of structural defects, such as 5 or 7 member sp2-bond C rings, make the nanostructure standing up freely towards open space. Literally, Carbon Nanosheet is comprised of a few layers of defected graphene. It is the inherent crystal structure defects, which makes the carbon nanomaterial different that an ideal model of Graphene. The unique structure and morphology of Carbon Nanossheets results from two-dimensional preferential crystal growth of the carbon material in a special plasma process condition.

By virtue of their graphene and graphitic structure, Carbon Nanosheets have very high electrical conductivity. Graphene is known as one of the strongest materials, and it has a breaking strength over 100 times greater than that of a hypothetical steel film of the same thickness. Morphology of Carbon Nanosheets can remain stable at temperatures up to 1000° C. A Carbon Nanosheet has a large specific surface area because of its sub-nanometer thickness. Referring to FIG. 2, it shows the structure of Carbon Nanosheet 220 standing up freely on a substrate 210. With only 1 to 7 layers of graphene, the Carbon Nanosheet is less than 2 nm thick. Its height and length is about 1 micrometer respectively. The structure and fabrication method of Carbon Nanosheets have been published in several peer-reviewed journals such as: Wang, J. J. et al., “Free-standing Subnanometer Graphite Sheets”, Applied Physics Letters 85, 1265-1267 (2004); Wang, J. et al., “Synthesis of Carbon Nanosheets by Inductively Coupled Radio-frequency Plasma Enhanced Chemical Vapor Deposition”, Carbon 42, 2867-72 (2004); Wang, J. et al., “Synthesis and Field-emission Testing of Carbon Nanoflake Edge Emitters”, Journal of Vacuum Science & Technology B 22, 1269-72 (2004); French, B. L., Wang, J. J., Zhu, M. Y. & Holloway, B. C., “Structural Characterization of Carbon Nanosheets via X-ray Scattering”, Journal of Applied Physics 97, 114317-1-8 (2005); Zhu, M. Y. et al., “A mechanism for Carbon Nanosheet formation”, Carbon, 2007.06.017; Zhao, X. et al., “Thermal Desorption of Hydrogen from Carbon Nanosheets”, Journal of Chemical Physics 124, 194704 (2006), as well as described by Zhao, X. in U.S. Patent “Supercapacitor using Carbon Nanosheets as electrode” (U.S. Pat. No. 7,852,612 B2); and Wang, J. et al., in U.S. Patent “Carbon nanostructures and methods of making and using the same” (U.S. Pat. No. 8,153,240 B2), which are incorporated herein by reference in their entirety.

As described above, the VG is a novel material which is distinctly different from the ideal model Graphene material with one or two atomic layers laying on a plane substrate, Graphite, Carbon Nanotubes, Carbon Nanowalls, Petal Like Graphitic Sheets, Carbon Nanoflakes, Graphene Nanoplatelets, Aggregated Graphene from exfoliated graphite, etc. The vertically free standing graphene contaning Carbon Nanosheet is also called Fluffy Graphene or CNS as a trade name by the inventors. Noticeably, Petal like Graphitic Sheets, Carbon Nanowalls and Carbon Nanoflakes had a similar free standing morphology, and these carbon nanomaterials were invented by comtemporary materials scientists in early years of 2000's. However, those carbon nanomaterials could not be treated as a graphene material, because its graphitic thickness is more than ten nanometers, or thicker than ten atomic layers of graphene. By changing the crystal structure and sheet thickness, Carbon Nanosheet has distinct physical and chemical properties than those materials.

### BRIEF SUMMARY OF THE INVENTION

This invention is about a product of a flip-chip thin-film hybrid screen printed electrode (FCTFHSPE). It combines a primary screen printed electrode (SPE) device and a thin film material coated chip, in order to make a hybridized product. The product is used as a test strip for electrochemical analysis, such as environmental, bio-electrochemical and biomedical sensors. The hybridized electrodes design takes the benefits of low cost of screen printing technology, and high sensitivity of thin film coating nanotechnology. This invention is also about applying a flip chip method to manufacture the hybrid electrode. A chip of thin film material coated solid state substrate is surface mounted to a preliminary perforated SPE by a flip chip method/process. This method/process is fast, easy, cheap, uniform, and suitable for large scale manufacturing.

### BRIEF DESCRIPTION OF DRAWINGS

FIG. 1 is a perspective view showing the front, the left side, and the top of the flip chip thin film hybrid screen printed electrode test strip;

FIG. 2 includes an exploded view, a top view, a bottom view, and a schematic cross section view at the axis of symmetry, thereof;

FIG. 3 is a perspective view of a chip of a thin film material coated solid state substrate, and microscopic view of the thin film coating material: vertically free standing graphene containing carbon nanosheets;

FIG. 4 is a top view of a set of variants of the flip chip thin film hybrid screen printed electrode test strips;

FIG. 5 is a top view of a second set of variants of the flip chip thin film hybrid screen printed electrode test strips;

FIG. 6 is a top view of a third set of variants of the flip chip thin film hybrid screen printed electrode test strips.

### DETAILED DESCRIPTION OF THE INVENTION

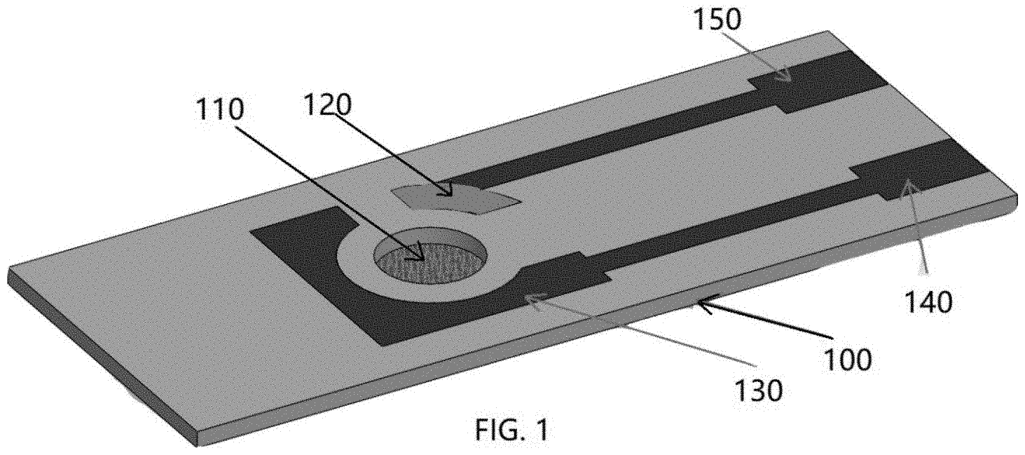

Referring now to the invention in more details, in FIG. 1, it shows a flip chip thin film hybrid screen printed electrode test strip (FCTFSPETS), where 100 is a main body or a substrate of the FCTFSPETS, 110 is a chip of a thin film material coated solid state substrate, 120 and 130 are a reference electrode and a counter electrode, 140 and 150 are electrode leads for the counter electrode and reference electrode respectively. 100 is usually made by polyethylene terephthalate (PET). 120, 130, 140 and 150 are printed on 100 by screen printing technology with various formulas and function, e.g. carbon paste containing a mixture of carbon ink and resin material being used for counter electrode, and silver paste being used for the electrode leads. Beside above mentioned, sometimes there are extra layers printed on the main body, e.g. insulating layers, protecting layers, logos, and texts. The thin film material 110 coated on the solid state substrate is exposed to the open space as a functioning work electrode material. An obvious benefit of this configuration is the thin film electrode material is geometrically recessed below the perforated hole structure, thus the thin film electrode materials can be protected against surface abrasion damage during manufacturing and logistic transportation.

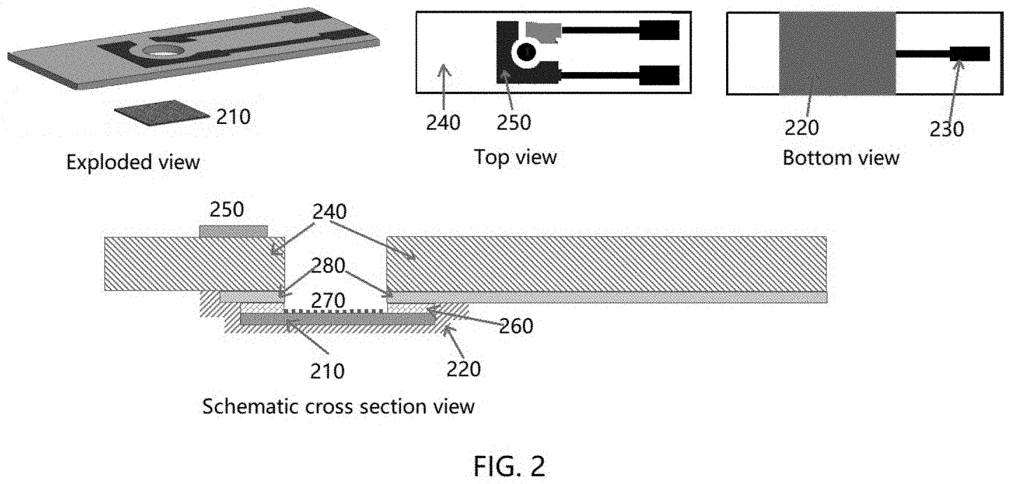

The exploded view of FIG. 2 shows how the thin film electrode material is attached to the down side surface of the primary SPE main body. A thin film material is by definition having thickness of 1 micron or less, which must coat (or called grow up in a strict Materials Science description) on a solid state substrate to work. 210 is a chip of solid state substrate with thin film electrode material growing on the up side surface. Flip chip technology means the up side of the chip, which has the thin film electrode material, is attached to the down side surface of a primary SPE main body via a glue material, while the thin film electrode material is exposed to open space, through the perforated hole of the SPE main body. In other words, between the surface mounted chip and the through-holed SPE down side surface, there is a layer of conductive or non-conductive glue material, in order to bonding the chip and primary SPE main body. Importantly, when choosing and applying the glue material, it has to be thin, no pollution and no disturbance to future electrochemical analysis work. The glue material must not cover the thin film coating exposed to open space.

The top view of FIG. 2 shows an actual functioning surface of the FCTFSPETS. In the bottom view of FIG. 2, 220 is a protecting layer for the solid state substrate (or the chip), and 230 is a lead of the working electrode made by thin film electrode material.

The schematic cross section view at the axis of symmetry of FIG. 2 further explains the flip chip technology, where 240 is the SPE main body, 250 is the counter electrode printed on SPE main body via screen printing technology, 280 is a conductive layer printed on SPE main body via screen printing technology, 260 is the glue material to attach the up side surface of a chip of solid state substrate with thin film electrode material to the down side surface of a primary SPE main body, 220 is the protecting layer, and 270 is the thin film electrode material exposed to open space.

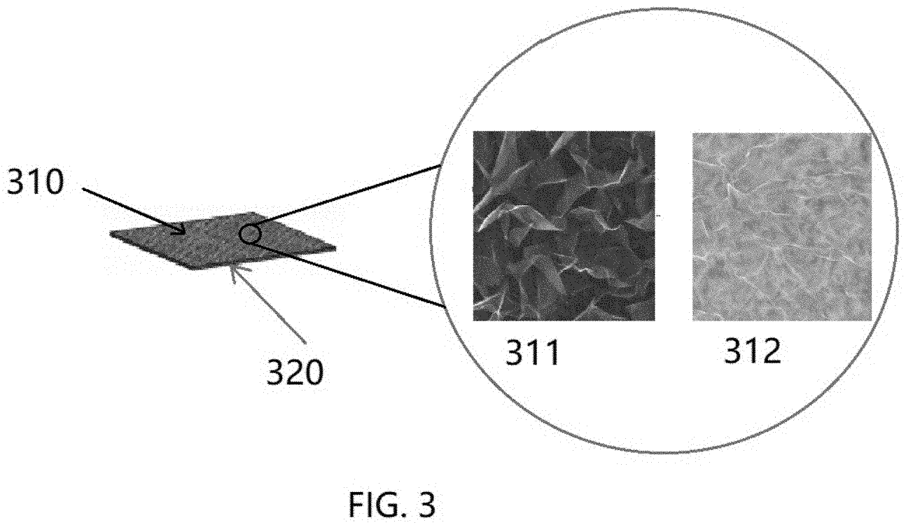

FIG. 3 gives an microscopic view of the solid state substrate 320 with thin film electrode material 310. 311 and 312 are scanning electron microscope (SEM) photos of vertical graphene and planer graphene as exemplary thin film electrode materials.

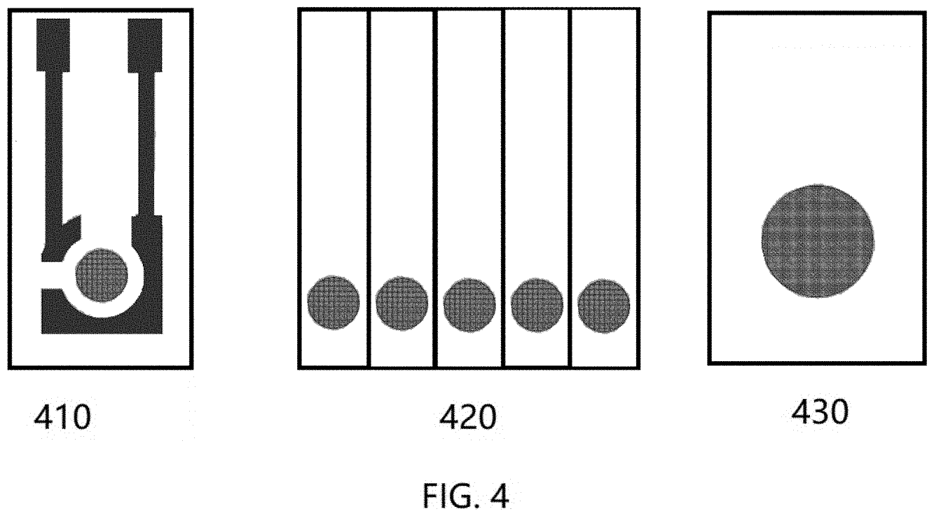

FIG. 4 gives a set of examples of variants of the invented flip chip thin film hybrid screen printed electrode test strips (FCTFSPETS) in a top view. 410 is a FCTFSPETS with an integrated reference electrode and an integrated counter electrode. 420 is a FCTFSPETS which is integrated with a row of FTSPETS unit. 430 is a FCTFSPETS only containing a single electrode.

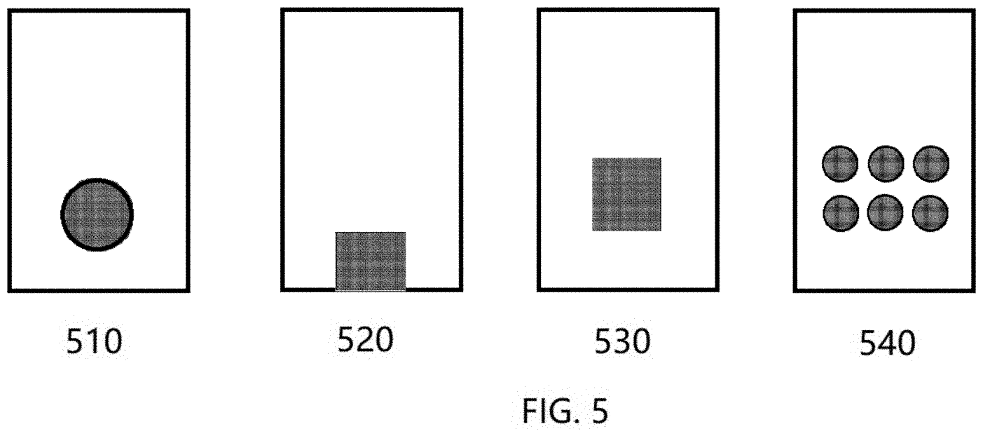

FIG. 5 gives a second set of examples of variants of the invented FTSPETS in a top view. The exposed functioning thin film electrode material can be round 510, located at the edge of the main body 520, rectangular 530, as an array of sub units 540, or other configurations.

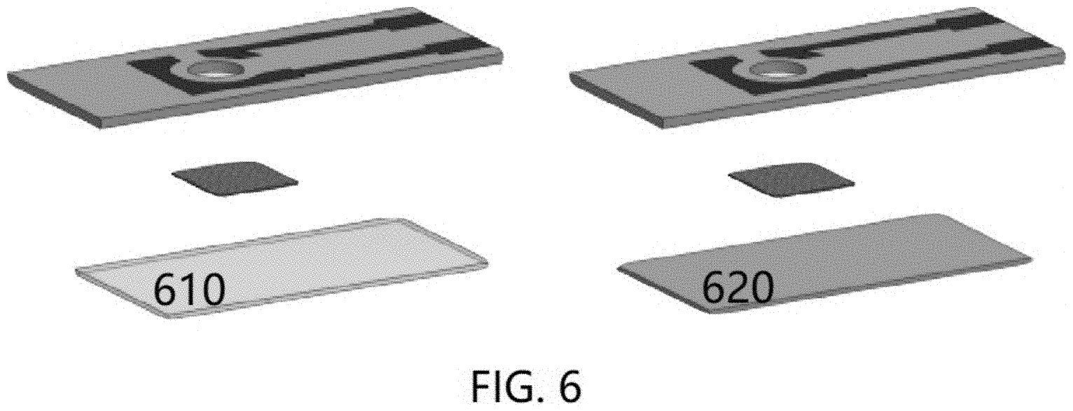

FIG. 6 gives a third set of examples of variants of the invented FTSPETS in an exploded view. At the chip's down side surface (no thin film coatings), there is a backplate to protect the FTSPETS. The backplate can be made by a variety of materials, e.g. a transparent material 610 often to be used in electrochemiluminescence, and an electrical conductive material 620 to enhance the conduction of FTSPETS.

1. A test strip for electrochemical stripping analysis, comprising:
a main body made of a insulative sheet material in a strip format, having a perforated hole, having a upside surface and down side surface;
a set of counter electrode, on the up side surface of the main body , in the proximity of the hole;
a set of reference electrode, on the up side surface of the main body, in the proximity of the hole;
a set of work electrode, made of a chip, mounted to the down side surface of the main body;

2. For the test strip product of the claim 1,
the work electrode chip is made of a solid state substrate, such as a piece of graphite paper, carbon paper, ceramics, mica, glass, polymer plastics, silicon wafer, and a thin film material is deposited on the chip surface;

3. For the test strip product of the claim 1,
the chip is coated by a thin film technology via a physical vapor deposition (PVD), a chemical vapor deposition (CVD), or a plasma enhanced chemical vapor deposition (CVD) method;

4. For the test strip product in the claim 1,
the thin film material is made of the vertically free standing graphene containing carbon nanosheets material (Vertical Graphene).

5. For the test strip product of the claim 1,
the sheet thickness of the test strip main body is in the range of 100 micrometers to 3 millimeters.

6. For the test strip product of the claim 1,
the perforated hole is in circular shape.

7. For the test strip product of the claim 1, wherein:
between the surface mounted chip and the test strip's down side surface, there is a layer of conductive or non-conductive glue material, in order to bonding the chip and down side surface.

8. For the test strip product of the claim 1, wherein:
the main body has a multiplicity of holes and comprise a multiplicity of reference electrodes and counter electrodes, and a multiplicity of work electrode chips mounted to each perforated holes respectively.

9. A method of making the test strip product in claim 1, includes but not limited to the processes of:
Step 1. To make a preliminary test strip main body, whose up and down side surface are both screen printed with traces of electrodes;
Step 2. To perforate the main body with a through hole;
Step 3. To apply a thin layer of a glue material on the down side surface.
Step 4. To surface mounting a chip to the down side surface before the glue drying or curing. The chip was preliminary deposited by a thin film material. The chip completely covers up and seals the perforated hole from the down side.
Step 5. To drying or curing the glue material till solidification in order to seal the perforated hole from the down side.
Step 6. To attach a protection backplate on the chip mounted down side.
